(19) United States
(12) Patent Application Publication
(10) Pub. No.: US 2010/0230330 A1
(43) Pub. Date: Sep. 16, 2010

(54) METHOD OF AND APPARATUS FOR THE PRE-PROCESSING OF SINGLE STREAM RECYCLABLE MATERIAL FOR SORTING

(75) Inventors: Farook Afsari, Menlo Park, CA (US); Punit Narendra Govenji, Los Altos Hills, CA (US); Ruddick Lawrence, NewYork, NY (US); Austin Lyon, Long Beach, CA (US); Sunthar Premakumar, Saratoga, CA (US)

Correspondence Address: HAVERSTOCK & OWENS LLP, 162 N WOLFE ROAD, SUNNYVALE, CA, 94086, US

(73) Assignee: eCullet, Menlo Park, CA (US)

(21) Appl. No.: 12/405,159

(22) Filed: Mar. 16, 2009

(51) Int. Cl. B07C 5/04; B07C 5/36; B07B 1/46; B07C 5/34

(52) U.S. Cl. 209/680; 209/248; 209/254; 209/643; 209/408

(57) ABSTRACT

A system for pre-processing material into groups of different sizes comprising three levels. The second level is positioned above the third level and below the first level. The first level comprising a feeding mechanism, one or more first screens coupled to ducts and having apertures, blowers and vacuum ducts, dust collectors and a diverter. The screens transport the material along the first level in a first direction while a portion is sifted away before being diverted to the second level. The second level comprising one or more second screens coupled to ducts and having apertures, blowers and vacuum ducts and a takeaway device. The screens transport the material along the second level in a second direction different than the first while a portion is sifted away before falling to the third level. The third level comprising blowers and vacuum ducts and takeaway devices for receiving a portion of the material.

### FIELD OF THE INVENTION

The invention relates to a method and apparatus for the pre-processing of recycling material in general, and specifically, to a method and apparatus for sifting material by size using a unique aperture shape and screen placement.

### BACKGROUND OF THE INVENTION

Currently, there is a need to preserve natural resources and reduce dependence on landfills and similar storage facilities. To meet this need, several processes and machines are used to identify and sift material. Often, this material is first processed by crushing the material in order to break the glass within the material into glass cullets, which are small pieces of glass of varying characteristics that are distinguished by color. These glass cullets then are sifted by size and separated from the remainder of the material so that they are able to be sorted by color and ultimately recycled. This sifting by size commonly involves transporting the material containing the glass cullets over a series of screens all on a single level allowing glass cullets of the appropriate size to fall through the apertures on the surface of the screen.

As full scale beneficiation has become more prevalent, the disadvantages of the current size sifting methods have been realized. First, the number of screens required to be included in the series to adequately sift the material by size is sufficiently large such that the sifters take up a large amount of floor space and require large warehouses to house them. Second, the screens are inaccurate in that the apertures along their surfaces often allow unwanted material to pass through such as stick-like objects that are able to fit through the apertures despite their excessive length if oriented correctly. If unchecked, these objects that pass through the apertures despite their size render the sifting process unsatisfactory and require the re-sifting of the material. Therefore, the large amount of floor space required coupled with the inaccuracy of the current size sifting methods add cost, energy and time to the sifting process.

### SUMMARY OF THE INVENTION

One aspect of the invention is directed to a system for pre-processing a stream of material to be recycled into separate groups of material of different sizes. The system comprises one or more first screens having a plurality of first apertures that receive and transport the material along a first level in a first direction. The system comprises one or more second screens having a plurality of second apertures that receive the material from the first level and transport the material along a second level in a second direction wherein the first level is positioned above the second level and the first direction is different than the second direction. In some embodiments, the first direction is substantially opposite the second direction. The system further comprises a feeding mechanism that delivers the stream of material to at least one of the first screens. The system also comprises one or more first ducts coupled to the one or more first screens that receive a first portion of the material that falls through the plurality of first apertures and one or more second ducts coupled to the one or more second screens that receive a second portion of the material that falls through the plurality of second apertures. Also, the system further comprises at least one first takeaway device that receives the first portion of the material from the one or more first ducts and at least one second takeaway device that receives the second portion of the material from the one or more second ducts. The first and second takeaway devices each comprising any combination of a sliding plate, conveyor belt or any other suitable conveying means. The system further comprises at least one diverter coupled to at least one of the first screens that diverts the material to the second level. The system further comprises one or more blowers and vacuum ducts that blow and suction away a third portion of the material from the first, second and third levels. The blowing and suctioning velocity of at least on of the blower and vacuum duct pairs is adjustable. In some embodiments, at least one of the blower and vacuum duct pairs is adjusted manually by at least one operator. In some embodiments, at least one of the blower and vacuum duct pairs is adjusted automatically by at least one computing device. The blowing and suctioning velocity of the at least one blower and vacuum duct pairs is adjusted based on the content of the stream of material. In some embodiments, at least one of the blower and vacuum duct pairs is configured in the multi-directional configuration. In some embodiments, the first apertures are circular and the second apertures are oblong, wherein oblong is defined as deviating from circular form by elongation in one dimension, and the shortest diameter line of the apertures is substantially parallel to the direction of motion of the material. In some embodiments, the length of the shortest diameter line of the first apertures is different than the length of the shortest diameter line of the second apertures. Particularly, in some embodiments, the shortest diameter line of the first apertures is approximately 0.25 inches and the shortest diameter line of the second apertures is approximately 2 inches. The system further comprises any number of dust collectors for suctioning away part of the material. In some embodiments, the system further comprises at least one sorter for receiving the first and second portion of the material from the first and second takeaway devices and sorting the first and second portions of the material. Also in some embodiments, the system comprises at least one subsequent sifting system that receives the material from the second level.

In another aspect of the invention, a screen is for sifting a stream of material into separate groups of material of different sizes. The screen comprises a surface and a plurality of apertures along the surface wherein the plurality of apertures are oblong, wherein oblong is defined as deviating from circular form by elongation in one dimension, and their shortest diameter line is substantially parallel to the direction of motion of the material. In some embodiments the plurality of apertures is circular. In some embodiments, the shortest diameter line of the apertures is approximately 0.25 inches. In another embodiment, the shortest diameter line of the apertures is approximately 2 inches.

In yet another aspect of the invention, a method is for sifting a stream of material into separate groups of material of different sizes. The method comprises receiving the material on a first level wherein the first level comprises one or more first screens having a plurality of first apertures. The method comprises transporting the material with the first screens along the first level in a first direction while a first portion of the material falls through the first apertures. The method comprises receiving the material on a second level from the first level wherein the second level comprises one or more second screens having a plurality of second apertures. The method comprises transporting the material with the second screens along the second level in a second direction while a second portion of the material falls through the second apertures wherein the first level is positioned above the second level and the first direction is different than the second direction. In some embodiments, the first direction is substantially opposite the second direction. The method further comprises delivering the stream of the material to at least one of the first screens with a feeding mechanism. The method further comprises receiving the first portion of the material that falls through the plurality of first apertures with one or more first ducts coupled to the one or more first screens and receiving the second portion of the material that falls through the plurality of second apertures with one or more second ducts coupled to the one or more second screens. The method also comprises receiving the first portion of the material from the one or more first ducts with at least one first takeaway device and receiving the second portion of the material from the one or more second ducts with at least one second takeaway device. The method also comprises diverting the material to the second level with at least one diverter coupled to at least one of the first screens. The method further comprises blowing and suctioning away a third portion of material from the first, second and third levels with any number of blowers and vacuum ducts. In some embodiments, at least one of the blower and vacuum duct pairs are positioned in a multi-directional configuration. The method also comprises suctioning away a part of the material from the first level with one or more dust collectors. In some embodiments, the method further comprises receiving the material from the second level with at least one subsequent sifting device. In some embodiments, the method further comprises directing the first and second portions of the material from the first and second takeaway devices to a sorter for sorting the first and second portions of the material. In some embodiments, the first and second apertures are oblong, wherein oblong is defined as deviating from circular form by elongation in one dimension, and their shortest diameter line is substantially parallel to the direction of motion of the material. In some embodiments, the first apertures are circular. In some embodiments, the shortest diameter line of the first apertures is different from the shortest diameter line of the second apertures. Particularly, in some embodiments, the shortest diameter line of the first apertures is approximately 0.25 inches and the shortest diameter line of the second apertures is approximately 2 inches.

### BRIEF DESCRIPTION OF THE DRAWINGS

FIG. 1A illustrates a profile view of an embodiment of the pre-processing mechanism in accordance with the present invention.

FIG. 1B illustrates a top view of an embodiment of the pre-processing mechanism in accordance with the present invention.

FIG. 1C illustrates a front view of an embodiment of the pre-processing mechanism in accordance with the present invention.

FIG. 1D illustrates a first and second screen with a cutout magnification of the apertures of each in accordance with the present invention.

FIG. 1E illustrates a front view of an alternate embodiment of the pre-processing mechanism in accordance with the present invention.

FIG. 1F illustrates a side view of a blower and vacuum duct pair in a multi-directional configuration in accordance with the present invention.

FIG. 2 illustrates a pre-processing system comprising the sifting mechanism in accordance with the present invention.

FIG. 3 illustrates a flow chart of the pre-processing method in the sifting system of the present invention.

### DETAILED DESCRIPTION OF THE PRESENT INVENTION

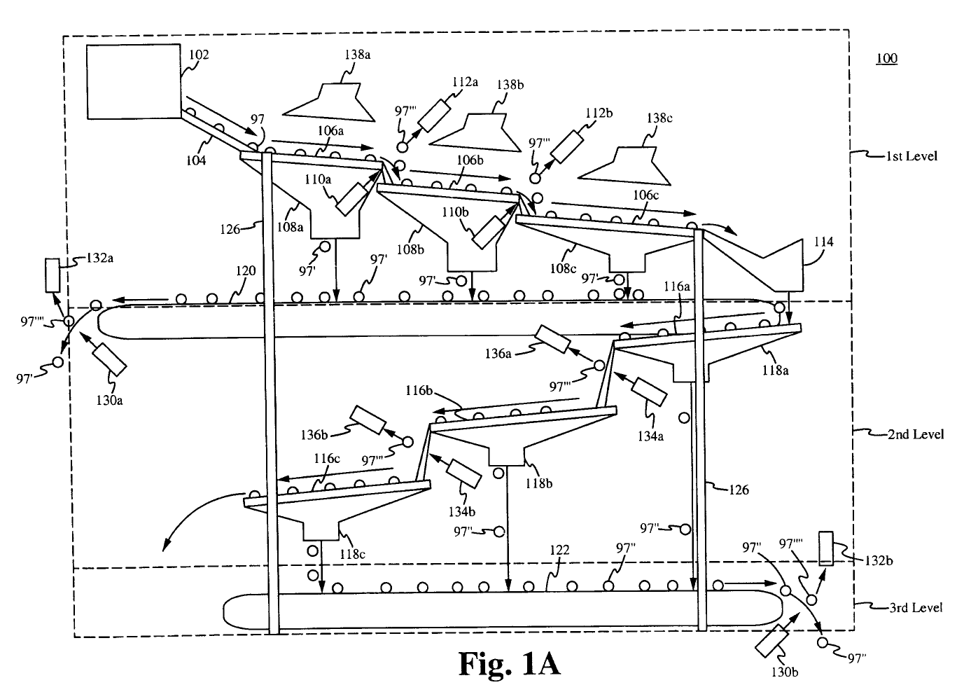

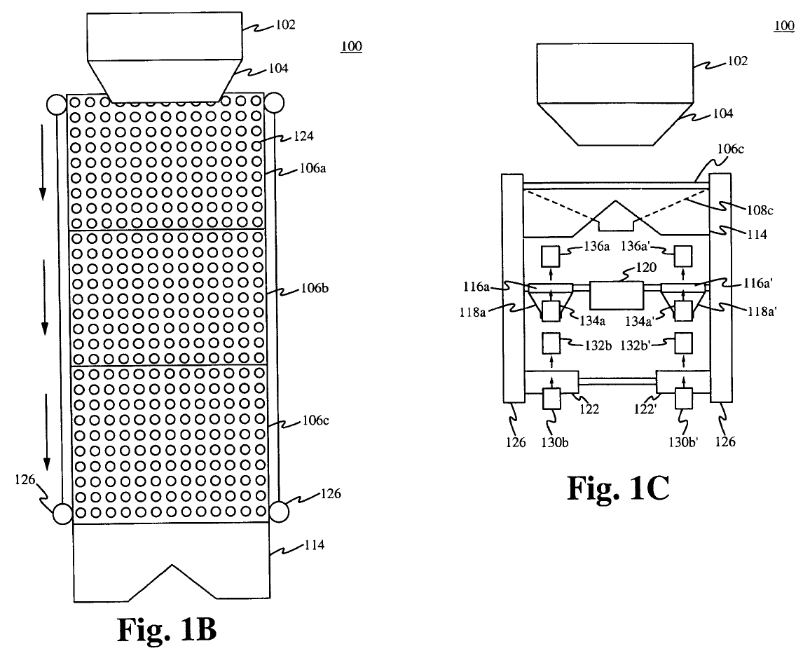

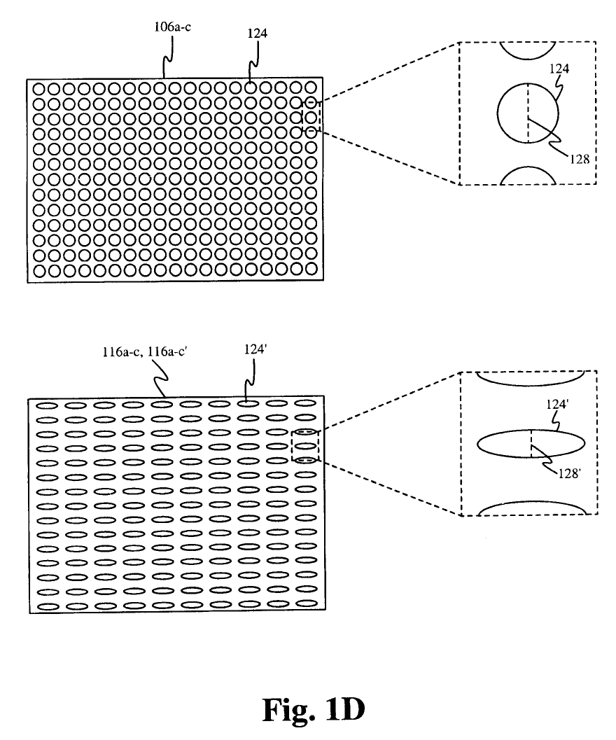

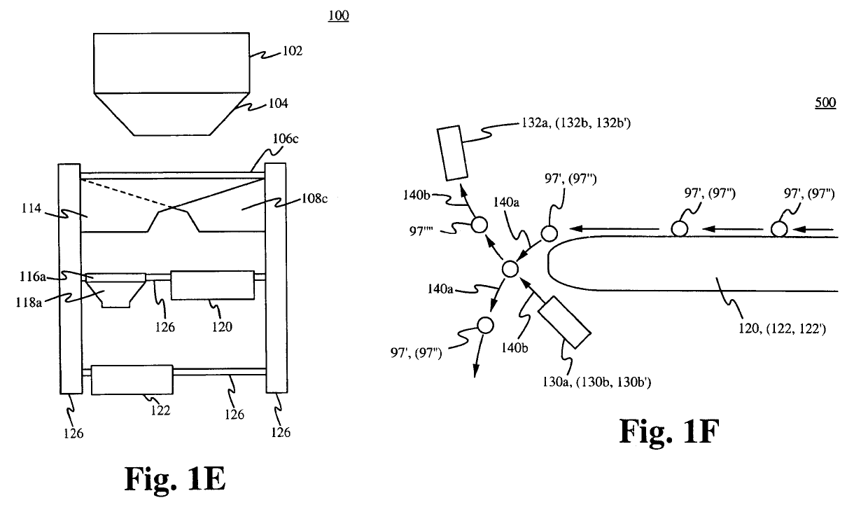

FIG. 1A illustrates a side view of an embodiment of the pre-processing system 100 in accordance with the present application. As shown in FIG. 1A, the pre-processing system 100 comprises a first, second and third level that are positioned such that the first level is directly above the second level and the third level is directly below the second level. Additionally, the first, second and third levels have substantially the same dimensions such that from a top view, as illustrated in FIG. 1B, the first level substantially obscures the view of the second and third levels. This “stacked” configuration allows the pre-processing system to occupy substantially less floor space than alternate configurations thereby decreasing required floor space, overhead and other costs.

The first level comprises a feeding mechanism 102 in communication with a series of three first screens 106a-c, each in communication with the next. In some embodiments, any number of first screens are able to be used to comprise the series. Alternatively, a single screen is able to be utilized instead of a series of screens. The series of three first screens 106a-c are positioned such that each overlap with any immediately adjacent first screen and each successive first screen is on a lower plane than the previous first screen as they move farther from the feeding mechanism 102 in the series. Also, each of the first screens 106a-c is tilted slightly away from the feeding mechanism 102. A set of first ducts 108a-c is coupled to the bottom of each first screen 106a-c and the last first screen 106c in the series is also coupled to a diverter 114 along its lowered edge due to the tilt described above. In some embodiments, the first ducts are incorporated into a single large first duct that is coupled to the bottom of all of the first screens 106a-c. Also, a first set of blower 110a, 110b and vacuum duct 112a, 112b pairs are positioned opposite one another straddling the path of the stream of material 97 at each of the gaps between the series of first screens 106a-c.

The blower 110a, 110b and vacuum duct 112a, 112b pairs are controllable such that the velocity of their suctioning and blowing is able to be adjusted. In some embodiments, the adjustment of the pairs is done manually by at least one operator. In some embodiments, the adjustment of the pairs is done automatically by at least one computing device. Alternately, any combination of manual and automatic adjustment is able to be made by any number of operators and computing devices. This adjustment of the blower and vacuum duct pair's velocity is based on a dynamic analysis of the content of the stream of material. Alternatively, any other suitable method of analysis of the content of the stream of material may be utilized. A set of dust collectors 138a-c are positioned substantially directly above the series of first screens 106a-c. Alternatively, any number of dust collectors is able to be used.

The second level comprises two series of three second screens 116a-c, 116a-c′, each in communication with the next, wherein the two series are opposite one another and straddle a takeaway device 120 that runs along the second level as shown in FIG. 1C. Alternatively, a single series of three second screens 116a-c is able to be used wherein the single series is positioned adjacent a takeaway device 120 as shown in FIG. 1E. In some embodiments, any number of second screens are able to be used to comprise the two series. Alternatively, two single screens is able to be utilized instead of two series of screens. Similar to the series of first screens 106a-c, the two series of second screens 116a-c, 116a-c′ are positioned such that each overlap with any immediately adjacent second screens, however in contrast with the first screens 106a-c, each successive second screen is on a lower plane as the two series move closer to the feeding mechanism 102 and each second screen is tilted slightly towards the feeding mechanism 102. Thus, the series of first screens 106a-c and series of second screens 116a-c, 116a-c′ direct the material 97 in different directions. In some embodiments, the series of first screens 106a-c and series of second screens 116a-c, 116a-c′ direct the material 97 in substantially opposite directions. This opposing directions system is beneficial because it permits the material 97 to transition from the end of the first level to the beginning of the second level easily while positioned in a “stack” configuration.

Two sets of second ducts 118a-c, 118a-c′ are coupled to the bottom of each series of second screens 116a-c, 116a-c′. In some embodiments, the ducts are incorporated into a single large second duct that is coupled to the bottom of all of the second screens. Also, in some embodiments, two second sets of blower 134a, 134a′, 134b, 134b′ and vacuum duct 136a, 136a′,136b, 136b′ pairs are positioned opposite one another straddling the path of the stream of material 97 at each of the gaps between the two series of second screens 116a-c, 116a-c′. The blower 134a, 134a′, 134b, 134b′ and vacuum duct 136a, 136a′,136b, 136b′ pairs are controllable such that the velocity of their suctioning and blowing is able to be adjusted. In some embodiments, the adjustment of the pairs is done manually by at least one operator. In some embodiments, the adjustment of the pairs is done automatically by at least one computing device. Alternately, any combination of manual and automatic adjustment is able to be made by any number of operators and computing devices. This adjustment of the blower and vacuum duct pair's velocity is based on a dynamic analysis of the content of the stream of material. Alternatively, any other suitable method of analysis of the content of the stream of material may be utilized.

A takeaway device 120 is positioned directly below the bottom of the first ducts 108a-c and in between the two series of second screens 116a-c, 116a-c′ as illustrated in FIG. 1C. Alternatively, the takeaway device 120 is positioned directly below the bottom of the first ducts 108a-c and adjacent a single series of second screens 116a-c as shown in FIG. 1E. The takeway device 120 is able to comprise a sliding plate, a conveyor belt or any other suitable conveying means or combination thereof. In some embodiments, a set of second dust collectors is able to be positioned substantially directly above the series of second screens 116a-c, 116a-c′. Also, a third blower 130a and vacuum duct 132a pair is positioned straddling the path of a first portion of the material 97′ in a multi-directional formation 500 (as discussed below and shown in greater detail in FIG. 1F) at the end of the takeaway device 120 as shown in FIG. 1A. The blower 130a and vacuum duct 132a pair is controllable such that the velocity of its suctioning and blowing is able to be adjusted. In some embodiments, the adjustment of the pair is done manually by at least one operator. In some embodiments, the adjustment of the pair is done automatically by at least one computing device. Alternately, any combination of manual and automatic adjustment is able to be made by any number of operators and computing devices. This adjustment of the blower and vacuum duct pair's velocity is based on a dynamic analysis of the content of the stream of material. Alternatively, any other suitable method of analysis of the content of the stream of material may be utilized.

As shown in FIG. 1F, the multi-directional configuration 500 comprises a blower 130a and vacuum duct 132a pair positioned such that they straddle the path of a stream of material 97′. Specifically, the vacuum duct 132a is facing downwards and positioned substantially parallel to the force of gravity and above the stream of material 97′ as the material 97′ falls in a waterfall path 140a toward the ground. The blower 130a is facing upwards and positioned below the material 97′ as it falls in the waterfall path 140a toward the ground. The blower 130a is also horizontally offset from the position of the vacuum duct 132a in a direction opposite that of the material's horizontal motion. Further, the blower 130a is angled away from a line parallel to the force of gravity in the direction of the material's horizontal motion. Thus, air blown from the blower 130a and suctioned by the vacuum duct 132a travels in an “upward waterfall” path 140b away from the ground. By utilizing the multi-directional configuration 500 in conjunction with the remainder of the system 100, the present application is able to better filter out unwanted material from the stream of material, thus increasing the efficiency and productivity of the system 100.

The third level comprises two second takeaway devices 122, 122′ positioned directly below the two sets of second ducts 118a-c, 118a-c′, as also illustrated in FIG. 1C. The two second takeaway devices 122, 122′ is able to comprise a sliding plate, a conveyor belt or any other suitable conveying means or combination thereof. Also, a fourth set of blower 130b, 130b′ and vacuum duct 132b, 132b′ pairs are positioned straddling the path of a second portion of the stream of material 97″ in a multi-directional formation 500 (as described above and shown in detail in FIG. 1F) at the end of the takeaway devices 122, 122′ as shown in FIG. 1A. The blower 130b, 130b′ and vacuum duct 132b, 132b′ pairs are controllable such that the velocity of their suctioning and blowing is able to be adjusted. In some embodiments, the adjustment of the pairs is done manually by at least one operator. In some embodiments, the adjustment of the pairs is done automatically by at least one computing device. Alternately, any combination of manual and automatic adjustment is able to be made by any number of operators and computing devices. This adjustment of the blower and vacuum duct pairs' velocity is based on a dynamic analysis of the content of the stream of material. Alternatively, any other suitable method of analysis of the content of the stream of material may be utilized. In alternative embodiments, the pre-processing system comprises any number of levels comprising any number of combinations of feeding mechanisms 102, series of screens, pairs of blowers and vacuum ducts, dust collectors, takeaway devices and diverters.

The pre-processing system 100 further comprises a frame 126 that is coupled to the pre-processing system 100 to provide support. The frame 126 is able to be any appropriate conventional type used or known in the art. In some embodiments, the frame 126 is coupled to the first screens 106a-c, the second screens 116a-c, 116a-c′, the blowers 110a, 110b, the first takeaway device 120 and the second takeaway devices 122, 122′ to provide support for the system. In some embodiments, the frame 126 is coupled to the first screens 106a-c, the second screens 116a-c, 116a-c′, the first takeaway device 120 and the second takeaway devices 122, 122′ such that by vibrating the frame 126 all the coupled devices will also vibrate allowing a single vibration source configured to vibrate the frame 126 to simultaneously produce vibration-caused movement of material 97, 97′, 97″ along each of the devices coupled to the frame 126. Alternatively, any other vibration method or combination of methods is able to be used to vibrate the components of the system individually or conjunctively. It is apparent to one skilled in the art that the frame is able to be arranged in any number of configurations capable of providing support for the pre-processing system 100.

The pre-processing system of the present application has a number of component subsystems that work in conjunction with one another to effectively pre-process the material 97 into the desired groups of sizes. It is apparent to one skilled in the art that the pre-processing, preparation, post processing stages are incorporated into the present system. The pre-processing and preparation stages include a glass crushing operation and a glass washing operation, and the post processing stages include a sorting preparation. A crusher (not shown) crushes the material 97 into smaller pieces that are to be pre-processed. The details of the crusher (not shown) are well known in the art and are not discussed in detail herein. The post processing stages comprise a sorter as described in U.S. Pat. No. 7,351,929 B2 and incorporated herein.

The feeding mechanism 102 feeds the material 97 onto the initial first screen 106a on the first level, via an exit chute 104, substantially at the highest point of the initial first screen whereby the material 97 begins to be sifted as it travels across the surface of the series of first screens 106a-c. The feeding mechanism 102 delivers the material to the screens in a substantially constant flow. The stream of material 97 delivered by the feeding mechanism comprises any combination of different types of waste material such as unsorted recyclable material, sorted recyclable material (e.g. glass) and non-recyclable material.

As shown in FIG. 1D, the series of first screens 106a-c comprise a number of first apertures 124 along their surface. In some embodiments, these first apertures 124 are circular with a diameter line 128. In some embodiments, these first apertures 124 are oblong, wherein oblong is defined as deviating from circular form by elongation in one dimension, with the shortest diameter line of the apertures being approximately 0.25 inches and substantially parallel to the direction of motion of the material. When utilizing this oblong and parallel orientation, in contrast with circular form apertures, the first apertures 124 are able to more accurately separate material that has the desired diameter limitation in only two dimensions, such as width and length, from material that has the desired diameter in all three spacial dimensions, width, length and height. For example, apertures with an oblong shape and parallel orientation are better able to accurately separate material like a pencil, which has a limited diameter in two dimensions only, from sphere-like material that meets the diameter restriction in all spacial dimensions. In alternate embodiments, the first apertures are able to be of any shape, orientation, size and positioning on the surfaces of the first screens as well as any combination of different shapes, orientations, sizes and positions. Within the oblong screen, the apertures are able to be positioned in a uniform grid, as shown in FIG. 1D, or in any other appropriate pattern, such as offset, random or diagonal.

In operation, the series of first screens 106a-c simultaneously sift a first portion of the material 97′ and transport the remaining material 97 to the diverter 114 via vibration. In some embodiments, the set of dust collectors 138a-c simultaneously suction away lightweight unwanted material such as dust, paper and small pieces of metal from the surface of the first screens 106a-c as the material 97 travels across the surface of the first screens 106a-c. Each of the first screens 106a-c vibrate at various frequencies via the vibration of the frame 126 causing the material 97 received from the feeding mechanism 102 at the initial first screen 106a to travel down the slightly tilted surface of the initial first screen 106a and over the first apertures 124. Alternatively, the screens is able to be vibrated directly or by any other suitable vibration means individually or in conjunction.

A first portion of the material 97′ that is smaller than 0.25 inches in diameter thereby falls through the first apertures 124 and into the coupled first duct 108a. The initial first duct 108a receives the first portion of the material 97′ that is smaller than 0.25 inches and funnels it to the second level onto the first takeaway device 120. The first takeaway device 120 then transports this first portion of the material 97′ to the sorting system (not shown) for post processing. In some embodiments, the third blower 130a and vacuum duct 132a pair, positioned in the multi-directional configuration 500, cooperatively blow and suction away an unwanted fourth portion of the material 97″″ such as dust, plastics and metal from this first portion of the material 97′ as it falls off the edge of the first takeaway device 120 in a waterfall path 140a before the material arrives at the sorting system for post processing. Specifically, as shown in FIG. 1F, by cooperatively blowing and suctioning, the blower 130a and vacuum duct pair 132a create the “upward waterfall” air path 140b. This air path 140b is then used to intercept the fourth portion of the material 97″″ and redirect it from its original waterfall path 140a to the “upward waterfall” path 140b where it is blown and suctioned away into the vacuum duct 132a. As described above, the velocity of the blown and suctioned air along path 140b is able to be adjusted either manually by an operator, automatically by a computing device, or by any combination thereof based on an analysis of the content of the stream of material 97′. Further, the analysis is able to be dynamic or by any other suitable analysis method.

The remaining material 97 falls off the edge of the initial first screen 106a in a waterfall path onto the substantially highest point of the next first screen 106b. In some embodiments, during this waterfall path the initial blower 110a and vacuum duct 112a pair, which straddle the waterfall path of the material 97 between the first screens 106a, 106b, then cooperatively blow and suction away a lightweight third portion of the material 97′″, such as paper. As described above, the velocity of the blown and suctioned air is able to be adjusted either manually by an operator, automatically by a computing device, or by any combination thereof based on an analysis of the content of the stream of material 97. Further, the analysis is able to be dynamic or by any other suitable analysis method.

The material 97 then repeats this path for each subsequent first screen, first duct and blower and vacuum duct pair, until it falls off the edge of the last first screen 106c and into the diverter 114. Thus, the remaining material 97 that reaches the diverter 114 is substantially without a lightweight third portion of the material 97′″ and a first portion of the material 97′ smaller than 0.25 inches in diameter.

The diverter 114 receives the remaining material 97 from the last first screen 106c and diverts it to the second level in two approximately equal streams onto substantially the highest point of the initial second screens 116a, 116a′ of the two series of second screens 116a-c, 116a-c′. In another embodiment, the diverter diverts the remaining material into any number of streams and onto any number of initial second screens. In yet another embodiment, there is no diverter and the remaining material falls in a waterfall path directly from the last first screen to the initial second screens.

As shown in FIG. 1D, the two series of second screens 116a-c, 116a-c′ comprise a number of second apertures 124′ along their surface. In some embodiments, these second apertures 124′ are oblong, wherein oblong is defined as deviating from circular form by elongation of one dimension, with their shortest diameter line 128′ being approximately 2 inches and substantially parallel to the direction of motion of the material. As described above, in contrast with circular apertures, an oblong shape and parallel orientation such as this has the effect of increasing the separation accuracy of the apertures. In alternate embodiments, the second apertures are able to be of any shape, orientation, size and positioning on the surfaces of the second screens as well as any combination of different shapes, orientations, sizes and positions. In operation, the two series of second screens 116a-c, 116a-c′ simultaneously sift a second portion of the material 97″ and transport the remaining material 97 to the second takeaway devices 122, 122′ via vibration. The series of second screens 116a-c, 116a-c′ vibrate via the frame 126 causing the material 97 received from the diverter 114 at the initial second screens 116a, 116a′ to travel down the slightly tilted surfaces of the initial second screens 116a, 116a′ and over the second apertures 124′. Alternatively, the screens is able to be vibrated directly or by any other suitable vibration means individually or in conjunction. A second portion of the material 97″ that is smaller than 2 inches in diameter thereby falls through the second apertures 124′ and into the coupled second ducts 118a-c, 118a-c′.

The initial second ducts 118a, 118a′ receive the second portions of the material 97″ that are smaller than 2 inches and funnel them to the third level onto the second takeaway devices 122, 122′. The second takeaway devices 122, 122′ then transport these second portions of the material 97″ to the sorting system (not shown) for post processing. In some embodiments, the fourth blower 130b, 130b′ and vacuum duct 132b, 132b′ pairs, positioned in the multi-directional configuration 500, cooperatively blow and suction away an unwanted fourth portions of the material 97″″ such as dust, plastics and metal from these second portions of the material 97″ as it falls off the edge of the second takeaway devices 122, 122′ in a waterfall path 140a before the material arrives at the sorting system for post processing. Specifically, by cooperatively blowing and suctioning, the blower 130b, 130b′ and vacuum duct 132b, 132b′ pairs create the “upward waterfall” air path 140b. This path 140b is then used to intercept the fourth portion of the material 97″″ and redirect it from its original waterfall path 140a to the “upward waterfall” path 140b where it is blown and suctioned away into the vacuum ducts 132b, 132b′. As described above, the velocity of the blown and suctioned air along the “upward waterfall” path 140b is able to be adjusted either manually by an operator, automatically by a computing device, or by any combination thereof based on an analysis of the content of the stream of material 97″. Further, the analysis is able to be dynamic or by any other suitable analysis method.

The remaining material 97 falls off the edge of the initial second screens 116a, 116a′ in a waterfall path onto the substantially highest point of the next second screens 116b, 116b′. In some embodiments, during this waterfall path the initial second blower 134a, 134a′ and vacuum duct 136a, 136a′ pairs, which straddle the waterfall path of the remaining material 97 between the second screens 116a, 116b, then cooperatively blow and suction away a lightweight third portion of the material 97′″, such as paper. As described above, the velocity of the blown and suctioned air is able to be adjusted either manually by an operator, automatically by a computing device, or by any combination thereof based on an analysis of the content of the stream of material 97. Further, the analysis is able to be dynamic or by any other suitable analysis method. The material 97 then repeats this path for each subsequent second screen, second duct and blower and vacuum duct pair until it falls off the edge of the last second screens 116c, 116c′. Thus, the remaining material 97, which is predominantly larger in diameter than 2 inches, is transported to the crusher (not shown) for re-crushing. In another embodiment, this remaining material 97 is then transported from the crusher back to the feeding mechanism 102 and back through the pre-processing system.

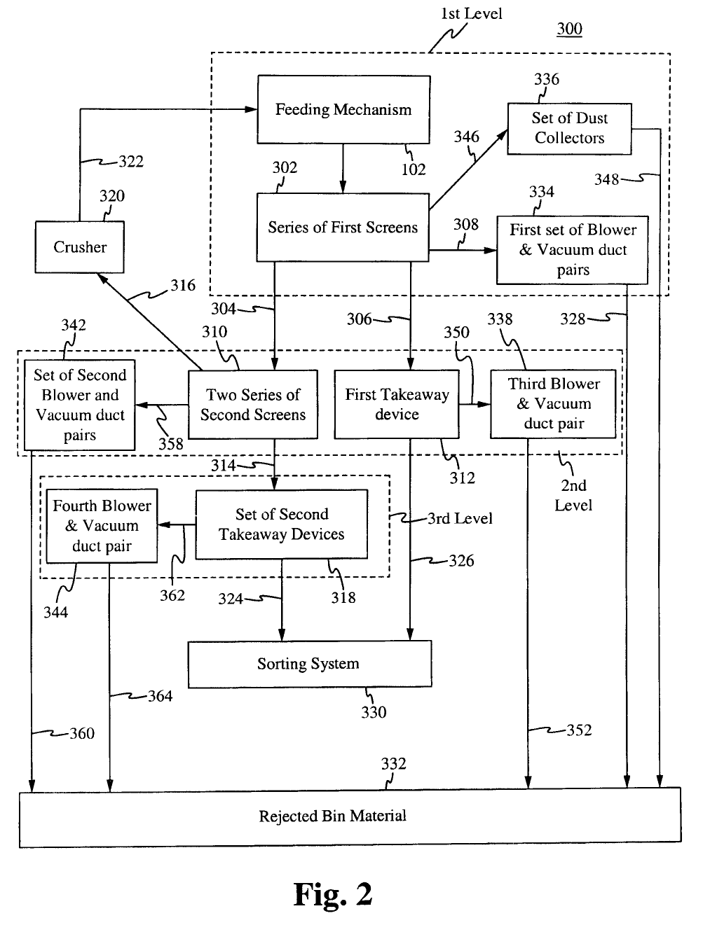

FIG. 2 illustrates a pre-processing system 300 in accordance with the present application. It should be noted that the description regarding the pre-processing techniques and screens described above in relation to FIGS. 1A-1F is applicable to the pre-processing apparatus in FIG. 2. As shown in FIG. 2, the pre-processing system 300 includes a feeding mechanism 102 in communication with a series of first screens 302 on a first level. The series of first screens 302 in communication with a set of blower and vacuum duct pairs 314, a set of dust collectors 336, a first takeaway device 312 on the second level, and two series of second screens 310 on the second level. The series of second screens 310 in communication with a second set of blower and vacuum duct pairs 342 and a set of second takeaway devices 318 on the third level. The first takeaway device 312 in communication with a third blower and vacuum duct pair 338. The set of second takeaway devices 318 in communication with a fourth set of blower and vacuum duct pairs 344.

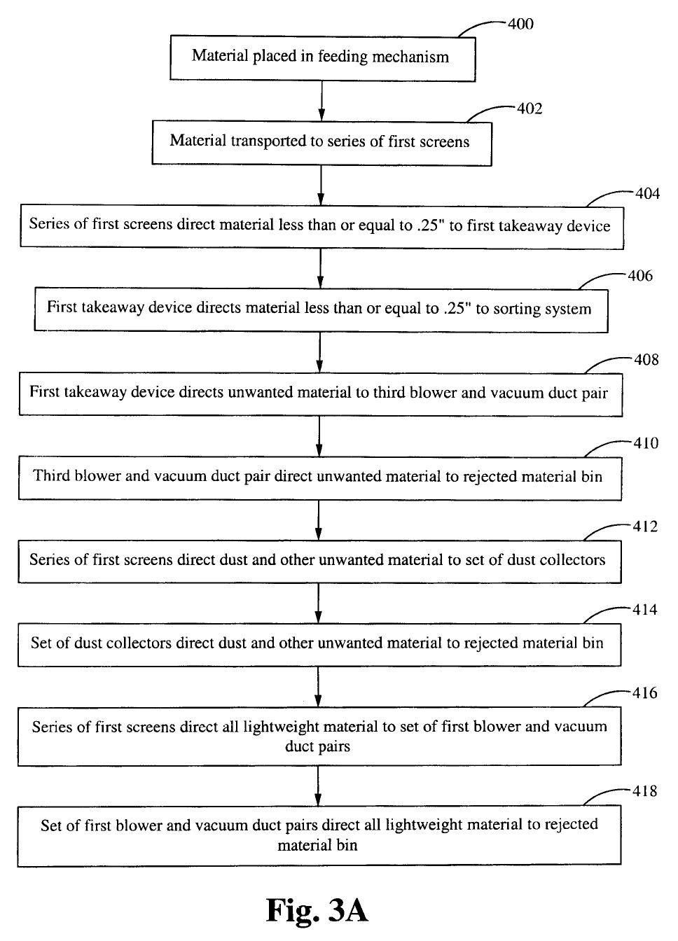

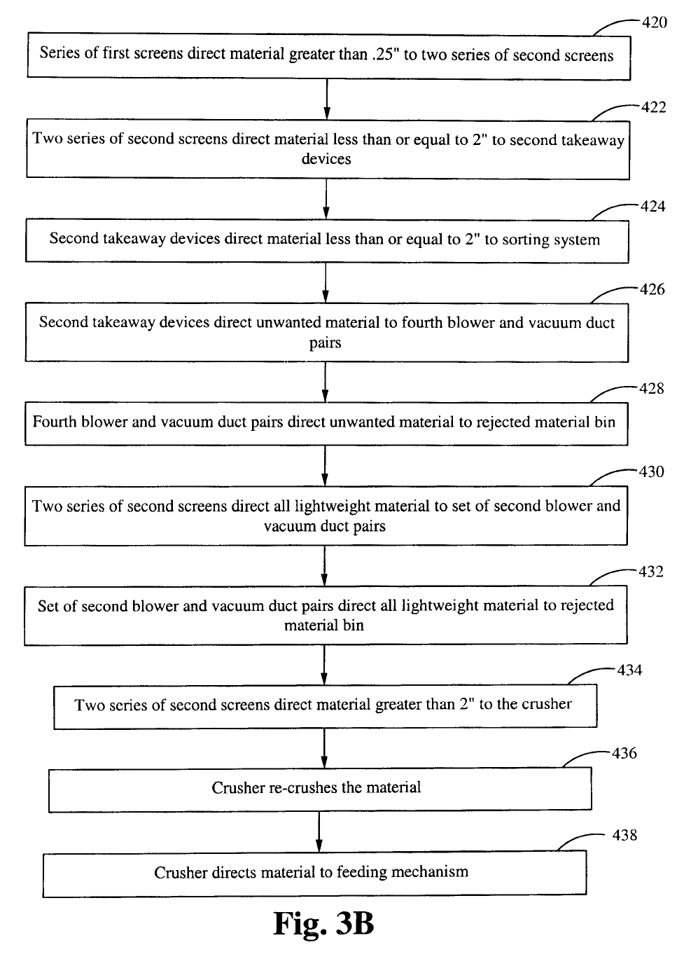

The operation of the pre-processing system 300 of the present application will now be discussed in conjunction with the flow chart illustrated in FIGS. 3A and 3B. In particular, crushed material is placed in the feeding mechanism 102 at the step 400. It should be noted that the material in the feeding mechanism 102 undergoes preprocessing procedures as discussed above before being placed in the feeding mechanism 102. The material is transported via a transport mechanism, such as an exit chute 104, from the feeding mechanism 102 to the series of first screens 302 on the first level at the step 402. The transport mechanism used to deliver the material to the series of first screens 302 are able to be any appropriate conventional type used or known in the art and is not discussed in detail herein.

The series of first screens 302 operate in the manner discussed above and direct the material in one of four paths, 304, 306, 308, 346. The series of first screens 302 sift out substantially all of the material that is less than or equal to 0.25 inches in diameter into the path 306. The material that is less than or equal to 0.25 inches in diameter is thus funneled to the second level onto the first takeaway device 312 at the step 404. The first takeaway device 312 then directs the material less than or equal to 0.25 inches along path 326 to the sorting system 330 at the step 406. The first takeaway device 312 also directs unwanted material along path 350 to the third blower and vacuum duct pair 338 at the step 408. Thus the third blower and vacuum duct pair 338 blow and suction away the unwanted material and direct along path 352 to the rejected material bin 332 at the step 410. The series of first screens 302 also direct dust and other unwanted material along path 346 to the set of dust collectors 336 at the step 412. Thus, the set of dust collectors suction the dust and unwanted material along path 348 to the rejected material bin 332 at the step 414. The series of first screens 302 then direct all lightweight material along path 308 to the first set of blower and vacuum duct pairs 334 at the step 416. Thus the first set of blower and vacuum duct pairs 334 blown and suction away the lightweight material along path 328 to the rejected material bin 332 at the step 418. The series of first screens 302 direct the material that is greater than 0.25 inches in diameter into the path 304. The material that is greater than 0.25 inches is thus transported to the two series of second screens 310 on the second level at the step 420.

The two series of second screens 310 also operate in the manner discussed above and direct the material in one of the two paths, 314, 316. The two series of second screens 310 sift out substantially all of the material that is less than or equal to 2 inches in diameter into the path 314. The material that is less than or equal to 2 inches in diameter is thus funneled to the third level onto the second takeaway devices 318 at the step 422. The second takeaway devices 318 then directing the material less than or equal to 2 inches along path 324 to the sorting system 330 at the step 424. The second takeaway devices 318 also directing unwanted material along path 362 to the fourth blower and vacuum duct pairs 344 at the step 426. Thus, the fourth blower and vacuum duct pairs 344 blow and suction away the unwanted material along path 364 to the rejected material bin 332 at the step 428. The two series of second screens 310 direct all lightweight material along path 358 to the set of second blower and vacuum duct pairs 342 at the step 430. The set of second blower and vacuum duct pairs 342 thus blowing and suctioning away the lightweight material along path 360 to the rejected material bin 332 at the step 432. The two series of second screens 310 direct the material that is greater than 2 inches in diameter into the path 316. The material that is greater than 2 inches in diameter is thus directed to the crusher 320 at the step 434.

The crusher 320, which is a part of the preprocessing discussed above and not described in detail herein, then re-crushes the material in the step 436 and directs it along path 322 back to the feeding mechanism 102 in the step 438. The transport mechanism used to deliver the material to the feeding mechanism 102 is able to be any appropriate conventional type used or known in the art and is not discussed in detail herein.

The method of and apparatus for the pre-processing of recyclable material to be sorted described herein comprises three levels in a “stacked” configuration and series of screens comprising the first two levels positioned in different directions. In some embodiments, the first two levels are positioned in substantially opposite directions. The series of screens having a surface that has circular and oblong apertures wherein the shortest diameter line of the apertures is parallel to the direction of motion of the material for the sifting of material by size. This “stacked” configuration is particularly advantageous because it allows the pre-processing system to occupy substantially less floor area than alternate configurations and thereby decreases the required floor space, overhead and other costs. Further, the different direction of motion between the two levels of screens allows the “stacked” configuration to work efficiently as the material is able to easily be transferred from the end of one series of screens to the beginning of the next series. Further, utilizing oblong apertures that are oriented parallel to the direction of motion of the material is similarly advantageous because the apertures are able to more accurately separate material that has the desired diameter limitation in only two dimensions, such as width and length, from material that has the desired diameter in all three spacial dimensions, such as width, length and height. For example, in contrast with circular apertures, oblong apertures with a parallel orientation are able to more accurately separate material like a pencil, which has a limited diameter in two dimensions only, from sphere like material that meets the diameter restriction in all spacial dimensions. Moreover, supplementing the system with blower and vacuum duct pairs positioned in a multi-directional configuration further enhances the system's efficiency and overall effectiveness by adding another effective method of removing unwanted material. Consequently, the method of and apparatus for the pre-processing of recyclable material to be sorted described herein has numerous advantages.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Particularly, the scalability of the present sorting system 330 allows for any volume of material.

What is claimed is:

1. A system for sifting a stream of material comprising:
a. a first level comprising one or more first screens having a plurality of first apertures, wherein the first screens transport the material along the first level in a first direction; and
b. a second level comprising one or more second screens having a plurality of second apertures, wherein the second screens receive the material from the first level and transport it along the second level in a second direction;
wherein the first level is positioned above the second level and the first direction is different than the second direction.

2. The system according to claim 1 wherein the first level further comprises a feeding mechanism configured to deliver the stream of the material to at least one of the first screens.

3. The system according to claim 2 wherein the first level further comprises one or more first ducts coupled to the one or more first screens for receiving a first portion of the material that falls through the plurality of first apertures and wherein the second level further comprises one or more second ducts coupled to the one or more second screens for receiving a second portion of the material that falls through the plurality of second apertures.

4. The system according to claim 3 wherein the second level further comprises at least one first takeaway device for receiving the first portion of the material from the one or more first ducts.

5. The system according to claim 4 further comprising a third level comprising at least one second takeaway device for receiving the second portion of the material from the one or more second ducts, wherein the third level is positioned below the second level.

6. The system according to claim 5 wherein the at least one first and second takeaway devices each comprise any combination of a sliding plate, a conveyor belt or any other suitable conveying means.

7. The system according to claim 6 wherein the first level further comprises at least one diverter coupled to at least one of the first screens for diverting the material.

8. The system according to claim 7 wherein the first, second and third levels further comprise any number of blower and vacuum duct pairs for blowing and suctioning away a third portion of the material from the first, second and third levels.

9. The system according to claim 8 wherein the blowing and suctioning velocity of at least one of the blower and vacuum duct pairs is adjustable.

10. The system according to claim 9 wherein the blowing and suctioning velocity of the at least one of the blower and vacuum duct pairs is adjusted manually by at least one operator.

11. The system according to claim 9 wherein the blowing and suctioning velocity of the at least one of the blower and vacuum duct pairs is adjusted automatically by at least one computing device.

12. The system according to claim 9 wherein the blowing and suctioning velocity of the at least one of the blower and vacuum duct pairs is adjusted based on the content of the material.

13. The system according to claim 8 wherein at least one of the blower and vacuum duct pairs is positioned in a multi-directional configuration.

14. The system according to claim 1 wherein the first apertures are circular and the second apertures are oblong wherein oblong is defined as deviating in shape from circular form by elongation in one dimension.

15. The system according to claim 1 wherein the shortest diameter line of the second apertures is substantially parallel to the direction of motion of the material.

16. The system according to claim 1 wherein the diameter line of the first apertures is approximately 0.25 inches and the shortest diameter line of the second apertures is approximately 2 inches.

17. The system according to claim 8 further comprising at least one subsequent sifting device for receiving the material from the second level.

18. The system according to claim 1 wherein the shortest diameter line of the first apertures is different than the shortest diameter line of the second apertures.

19. The system according to claim 8 wherein the first level further comprises any number of dust collectors for suctioning away part of the material.

20. The system according to claim 8 further comprising at least one subsequent sifting system that receives the material from the second level.

21. The system according to claim 8 further comprising at least one sorter for receiving the first and second portion of the material from the first and second takeaway devices for sorting the first and second portions of the material.

22. A system for sifting a stream of material comprising:
a. a first level comprising:
i. a feeding mechanism configured to deliver the stream of material;
ii. one or more first screens having a plurality of first apertures, wherein the first screens receive the material from the feeding mechanism and transport the material along the first level in a first direction;
iii. one or more first ducts coupled to the one or more first screens for receiving a first portion of the material that falls through the plurality of first apertures;
iv. one or more first dust collectors for suctioning away part of the material;
v. any number of first blower and vacuum duct pairs for blowing and suctioning away a third portion of the material from the first level; and
vi. at least one diverter coupled to at least one of the first screens for diverting the material;
b. a second level comprising:
i. one or more second screens having a plurality of second apertures, wherein the second screens receive the material from the at least one diverter and transport the material along the second level in a second direction;
ii. one or more second ducts coupled to the one or more second screens for receiving a second portion of the material that falls through the plurality of second apertures;
iii. any number of second blower and vacuum duct pairs for blowing and suctioning away the third portion of the material from the second level; and
iv. at least one first takeaway device for receiving the first portion of the material from the one or more first ducts; and
c. a third level comprising:
i. at least one second takeaway device for receiving the second portion of the material from the one or more second ducts; and
ii. any number of third blower and vacuum duct pairs for blowing and suctioning away the third portion of the material from the third level;
wherein the first level is positioned above the second level, the third level is positioned below the second level and the first direction is different than the second direction.

23. A screen for sifting a stream of material comprising:
a. a surface; and
b. a plurality of apertures along the surface wherein the plurality of apertures are oblong, wherein oblong is defined as deviating in shape from circular form by elongation in one dimension.

24. The screen according to claim 23 wherein the shortest diameter line of the plurality of apertures is substantially parallel to the direction of motion of the material.

25. The screen according to claim 23 wherein the shortest diameter line of the apertures is approximately 2 inches.

26. The screen according to claim 23 wherein the shortest diameter line of the first apertures is different than the shortest diameter line of the second apertures.

27. A method of sifting a stream of material comprising:
a. receiving the material on a first level wherein the first level comprises one or more first screens having a plurality of first apertures;
b. transporting the material with the first screens along the first level in a first direction while a first portion of the material falls through the first apertures;
c. receiving the material on a second level from the first level wherein the second level comprises one or more second screens having a plurality of second apertures; and
d. transporting the material with the second screens along the second level in a second direction while a second portion of the material falls through the second apertures;
wherein the first level is positioned above the second level and the first direction is different than the second direction.

28. The method according to claim 27 further comprising delivering the stream of the material to at least one of the first screens with a feeding mechanism.

29. The method according to claim 28 further comprising receiving the first portion of the material that falls through the plurality of first apertures with one or more first ducts coupled to the first screens and receiving the second portion of the material that falls through the plurality of second apertures with one or more second ducts coupled to the second screens.

30. The method according to claim 29 further comprising receiving the first portion of the material from the first ducts with at least one first takeaway device.

31. The method according to claim 30 further comprising receiving the second portion of the material from the second ducts on a third level, wherein the third level comprises at least one second takeaway device and the third level is positioned below the second level.

32. The method according to claim 31 further comprising diverting the material to the second level with at least one diverter coupled to at least one of the first screens.

33. The method according to claim 32 further comprising blowing and suctioning away a third portion of material from the first, second and third levels with any number of blower and vacuum duct pairs.

34. The method according to claim 33 further comprising suctioning away a part of the material from the first level with one or more dust collectors.

35. The method according to claim 34 wherein at least one of the blower and vacuum duct pairs are positioned in a multi-directional configuration.

36. The method according to claim 34 further comprising directing the first and second portions of the material from the first and second takeaway devices to a sorter for sorting the first and second portions of the material.

37. The method according to claim 34 further comprising receiving the material from the second levels with at least one subsequent sifting device.

38. The method according to claim 34 further comprising receiving the material from the

39. The method according to claim 27 wherein the second apertures are oblong wherein oblong is defined as deviating in shape from circular form by elongation in one dimension.

40. The method according to claim 27 wherein the shortest diameter line of the first and second apertures is substantially parallel to the direction of motion of the material.

41. The method according to claim 27 wherein the diameter line of the first apertures is approximately 0.25 inches and the shortest diameter line of the second apertures is approximately 2 inches.

42. The method according to claim 27 wherein the shortest diameter line of the first apertures is different than the shortest diameter line of the second apertures.
